(19) United States
(12) Patent Application Publication
(10) Pub. No.: US 2017/0300880 A1
(43) Pub. Date: Oct. 19, 2017

(54) Payment Approval Method and System

(71) Applicant: MASTERCARD ASIA/PACIFIC PTE LTD, SINGAPORE (SG)

(72) Inventors: Benjamin Charles Gilbey, Singapore (SG); Vijin Venugopalan, Singapore (SG); Prashant Sharma, Madison, NJ (US)

(21) Appl. No.: 15/485,905

(22) Filed: Apr. 12, 2017

(30) Foreign Application Priority Data
Apr. 13, 2016 (SG) 10201602905Q

(51) Int. Cl. G06Q 20/10; G06Q 20/32; G06Q 20/36

(52) U.S. Cl. CPC G06Q 20/102; G06Q 20/36; G06Q 20/325; G06Q 20/327

(57) ABSTRACT

There is provided methods and systems for approving a payment from a customer to a merchant. A merchant device, an approval server, a client device plus a method and system for configuring pre-approved payments from a customer to a merchant are also disclosed.

### CROSS-REFERENCE TO RELATED APPLICATION

This application claims the benefit of and priority to Singapore Patent Application No. 10201602905Q, filed Apr. 13, 2016. The entire disclosure of the above application is incorporated herein by reference.

### FIELD

This present disclosure relates to methods and systems for approving a payment from a customer to a merchant.

### BACKGROUND

This section provides background information related to the present disclosure which is not necessarily prior art.

Mobile payment services (Apple Pay, Android Pay, etc.) are becoming increasingly prevalent and allow consumers to make payments using a portable mobile device, such as a smart phone. However, such services may still involve some inconvenience, since customers have to remove the mobile device from a pocket or bag, confirm the transaction and provide authentication details (e.g., a personal identification number, password or biometric identifier, such as a fingerprint/retina scan). The payment process thus involves additional steps that do not add any value to the customer experience.

One approach for making payments easier has involved the customer setting up an account (hereafter referred to as a “tab”) with a merchant, which is to be paid at the end of the month (or some other predetermined period). However, traditional tabs can be prone to abuse, whilst more secure digital implementations of tabs introduce inconvenience by requiring ongoing user authorisations of purchases, even though there is only one actual payment transaction per month. Furthermore, the customer may be unable to easily monitor their level of expenditure on the tab and may experience “bill shock” at the end of the month.

It would be desirable to improve the efficiency of payments to merchants that a customer visits on a regular basis and trusts, for example, their local coffee shop, bar, convenience store, barber, nail technician, etc., whilst retaining customer control and security.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY

This section provides a general summary of the disclosure, and is not a comprehensive disclosure of its full scope or all of its features. Aspects and embodiments of the disclosure are also set out in the accompanying claims.

In a first aspect, there is provided a method for approving a payment from a customer to a merchant, the method being performed using a client device of the customer and a merchant device of the merchant, the method including: establishing a wireless communication connection between the client device and the merchant device in accordance with a prior association of the client device and the merchant device; in response to a customer order, the merchant device generating a payment request in accordance with the wireless communication connection; and, determining whether the payment request is in accordance with pre-approved payment parameters associated with the merchant, and in response to a successful determination, automatically approving a payment from a payment instrument of the customer to an account of the merchant in accordance with the payment request, without requiring any customer interaction with the client device.

Preferably, the prior association of the client device and the merchant device includes a wireless communication pairing of the client device and the merchant device.

It is preferable that the wireless communication pairing of the client device and the merchant device is performed using Bluetooth.

The payment request can include a payment amount and at least one of: a merchant identifier; a payment description; and, an itemized list of the customer order.

It is preferable that the method includes, prior to generating the payment request, identifying the customer associated with the client device in accordance with the wireless communication connection.

Preferably, identifying the customer includes: the merchant device displaying respective customer indications corresponding to respective client devices having a current wireless communication connection to the merchant device; and, the merchant device obtaining a selection of one of the customer indications based on manual input by the merchant.

It is preferable that each customer indication includes at least one of: a name of the respective customer; and, an image associated with the customer.

The method can include the client device transferring a customer indication to the merchant device. The customer indication can be transferred to the merchant device via the wireless communication connection.

Preferably, the method includes the merchant device transferring the payment request to the client device by at least one of: the merchant device directly transferring the payment request to the client device via the wireless communication connection; and, the merchant device transferring the payment request to an approval server via the Internet such that the approval server transfers the payment request to the client device via the Internet. The method can also include the client device determining whether the payment request is in accordance with pre-approved payment parameters associated with the merchant.

It is also preferable that the method includes: the merchant device transferring the payment request to an approval server; and, the approval server determining whether the payment request is in accordance with pre-approved payment parameters associated with the merchant. The pre-approved payment parameters can include at least one of: an approved maximum single payment amount; an approved daily payment limit; an approved frequency of payments; an approved time of day; and, approved goods or services. It is preferable that determining whether the payment request is in accordance with the approved daily payment limit includes accessing stored details of previous payments to the merchant on the same day; calculating a total daily payment amount based on payment amounts for the previous payments and a payment amount for the payment request; and, determining whether the total daily payment amount is within the approved daily payment limit.

Preferably, the approved frequency of payments includes an approved number of payments in a predetermined time period, and determining whether the payment request is in accordance with the approved frequency of payments includes: accessing stored details of previous payments to the merchant in the predetermined time period; and, determining whether a number of previous payments is less than the approved number of payments.

The method can include, in the event that the payment request is in accordance with approved payment parameters, causing the payment to be performed in accordance with the payment request using one of: a payment instrument token stored in a mobile wallet of the customer; and, a payment instrument token stored by the merchant.

It is also preferable that the method includes, in the event that the payment request is not in accordance with approved payment parameters, requesting manual authorisation of the payment request by the customer using the client device.

In a second aspect, there is provided a system for approving a payment from a customer to a merchant, the system including a client device of the customer and a merchant device of the merchant, the system being configured to: establish a wireless communication connection between the client device and the merchant device in accordance with a prior association of the client device and the merchant device; in response to a customer order, generate, in the merchant device, a payment request in accordance with the wireless communication connection; and, determine whether the payment request is in accordance with pre-approved payment parameters associated with the merchant, and in response to a successful determination, automatically approve a payment from a payment instrument of the customer to an account of the merchant in accordance with the payment request, without requiring any customer interaction with the client device.

Preferably, the system further includes an approval server configured to: receive the payment request; and, determine whether the payment request is in accordance with pre-approved payment parameters associated with the merchant. The approval server can be configured to cause the payment to be performed by communicating with a payment server.

There is also provided a method for approving a payment from a customer to a merchant, the method being performed using a merchant device of the merchant, the method including: the merchant device establishing a wireless communication connection with a client device of the customer in accordance with a prior association of the client device and the merchant device; in response to a customer order, the merchant device generating a payment request in accordance with the wireless communication connection; the merchant device transferring the payment request to an approval server that determines whether the payment request is in accordance with pre-approved payment parameters associated with the merchant, and in response to a successful determination, automatically approves a payment from a payment instrument of the customer to an account of the merchant in accordance with the payment request, without requiring any customer interaction with the client device; and, the merchant device receiving a successful payment notification from the approval server.

Preferably, the prior association of the client device and the merchant device includes a wireless communication pairing of the client device and the merchant device; and the wireless communication pairing of the client device and the merchant device is performed using Bluetooth. It is preferable that the payment request includes a payment amount and at least one of: a merchant identifier; a payment description; and, an itemized list of the customer order.

It is preferable that identifying the customer includes: the merchant device displaying respective customer indications corresponding to respective client devices having a current wireless communication connection to the merchant device; and, the merchant device obtaining a selection of one of the customer indications based on manual input by the merchant. Each customer indication can include at least one of: a name of the respective customer; and, an image associated with the customer. In addition, the method can also include the merchant device receiving the customer indication from the client device.

In another aspect, there is provided a merchant device for approving a payment from a customer to a merchant, the merchant device being configured to: establish a wireless communication connection with a client device in accordance with a prior association of the client device and the merchant device; in response to a customer order, generate a payment request in accordance with the wireless communication connection; transfer the payment request to an approval server that determines whether the payment request is in accordance with pre-approved payment parameters associated with the merchant, and in response to a successful determination, automatically approves a payment from a payment instrument of the customer to an account of the merchant in accordance with the payment request, without requiring any customer interaction with the client device; and, receive a successful payment notification from the approval server.

Furthermore, there is also provided a method for approving a payment from a customer to a merchant, the method being performed using an approval server, the method including: the approval server receiving, from a merchant device of the merchant, a payment request generated by the merchant device in response to a customer order and in accordance with a wireless communication connection established between a client device of the client and the merchant device in accordance with a prior association of the client device and the merchant device; and the approval server determining whether the payment request is in accordance with pre-approved payment parameters associated with the merchant, and in response to a successful determination, automatically approving a payment from a payment instrument of the customer to an account of the merchant in accordance with the payment request, without requiring any customer interaction with the client device. The pre-approved payment parameters include at least one of: an approved maximum single payment amount; an approved daily payment limit; an approved frequency of payments; an approved time of day; and, approved goods or services.

Preferably, determining whether the payment request is in accordance with the approved daily payment limit includes: accessing stored details of previous payments to the merchant on the same day; calculating a total daily payment amount based on payment amounts for the previous payments and a payment amount for the payment request; and, determining whether the total daily payment amount is within the approved daily payment limit.

It is preferable that the approved frequency of payments includes an approved number of payments in a predetermined time period, and determining whether the payment request is in accordance with the approved frequency of payments includes: accessing stored details of previous payments to the merchant in the predetermined time period; and, determining whether a number of previous payments is less than the approved number of payments.

Preferably, the method includes, in the event that the payment request is in accordance with approved payment parameters, the approval server causing the payment to be performed in accordance with the payment request using one of: a payment instrument token stored in a mobile wallet of the customer; and, a payment instrument token stored by the merchant. The method can include, in the event that the payment request is not in accordance with approved payment parameters, the approval server requesting manual authorisation of the payment request by the customer using the client device.

In a further aspect, there is also provided an approval server for approving a payment from a customer to a merchant, the approval server being configured to: receive, from a merchant device of the merchant, a payment request generated by the merchant device in response to a customer order and in accordance with a wireless communication connection established between a client device of the client and the merchant device in accordance with a prior association of the client device and the merchant device; and determine whether the payment request is in accordance with pre-approved payment parameters associated with the merchant, and in response to a successful determination, automatically approve a payment from a payment instrument of the customer to an account of the merchant in accordance with the payment request, without requiring any customer interaction with the client device. The approval server is preferably configured to cause the payment to be performed by communicating with a payment server.

There is also provided a method for approving a payment from a customer to a merchant, the method being performed using a client device of the customer, the method including: the client device establishing a wireless communication connection with a merchant device of the merchant in accordance with a prior association of the client device and the merchant device; the client device receiving, from a merchant device of the merchant, a payment request generated by the merchant device in response to a customer order and in accordance with the communication connection; and the client device determining whether the payment request is in accordance with pre-approved payment parameters associated with the merchant, and in response to a successful determination, automatically approving a payment from a payment instrument of the customer to an account of the merchant in accordance with the payment request, without requiring any customer interaction with the client device.

Plus, there is also provided a client device for approving a payment from a customer to a merchant, the client device being configured to: establish a wireless communication connection with a merchant device of the merchant in accordance with a prior association of the client device and the merchant device; receive, from a merchant device of the merchant, a payment request generated by the merchant device in response to a customer order and in accordance with the communication connection; and determine whether the payment request is in accordance with pre-approved payment parameters associated with the merchant, and in response to a successful determination, automatically approve a payment from a payment instrument of the customer to an account of the merchant in accordance with the payment request, without requiring any customer interaction with the client device.

Another aspect is a method for configuring pre-approved payments from a customer to a merchant, the method being performed using a client device of the customer and a merchant device of the merchant, the method including: associating the client device and the merchant device to allow a wireless communication connection to be established between the client device and the merchant device; determining a customer selection of pre-approved payment parameters associated with the merchant; and, storing the pre-approved payment parameters in a merchant profile to thereby allow payments to be made from a payment instrument of the customer to an account of the merchant in accordance with the pre-approved payment parameters associated with the merchant.

Finally, there is provided a system for configuring pre-approved payments from a customer to a merchant, the system including a client device of the customer and a merchant device of the merchant, the system being configured to: associate the client device and the merchant device to allow a wireless communication connection to be established between the client device and the merchant device; determine a customer selection of pre-approved payment parameters associated with the merchant; and, store the pre-approved payment parameters in a merchant profile to thereby allow payments to be made from a payment instrument of the customer to an account of the merchant in accordance with the pre-approved payment parameters associated with the merchant.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. With that said, an example of the present disclosure will now be described with reference to the accompanying drawings, in which:

FIG. 1 is a flow chart of an example of a method for approving a payment from a customer to a merchant;

FIG. 2 is a schematic diagram of an example of a distributed computer architecture;

FIG. 3 is a schematic diagram of an example of a processing system;

FIG. 4 is a schematic diagram of an example of an end station;

FIG. 5 is a schematic diagram of an example of a system configuration for approving a payment from a customer to a merchant;

FIGS. 6A to 6C are a flow chart of an example of a method for a customer configuring pre-approved payments with a merchant in the merchant's place of business; and

FIGS. 7A and 7B are a flow chart of an example of a method for automatically approving a payment in the merchant's place of business.

Corresponding reference numerals indicate corresponding parts throughout the several views of the drawings.

### DETAILED DESCRIPTION

Embodiments of the present disclosure will be described, by way of example only, with reference to the drawings. The description and specific examples included herein are intended for purposes of illustration only and are not intended to limit the scope of the present disclosure.

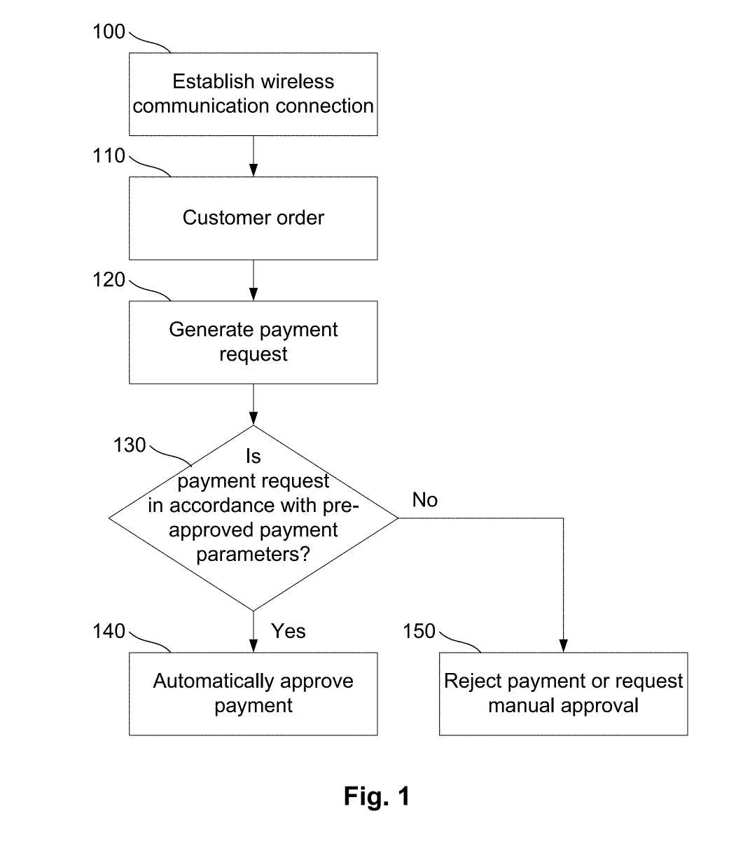

An example of a method for approving a payment from a customer to a merchant will now be described with reference to FIG. 1.

The method, as exemplified in FIG. 1, is performed using a client device of the customer and a merchant device of the merchant. The client device and the merchant device will generally be in the form of electronic processing devices, suitable examples of which will be described in further detail below. The devices will typically execute application software for enabling functionalities of the method, and different application software may be used by different devices.

For the purpose of this example, it will be assumed that the client device may be a suitably configured mobile device, such as a smart phone, that is carried by the customer, whilst the merchant device may be a suitably configured point-of-sale device, which may or may not be a mobile device depending on the particular context in which payments are to be approved. For instance, a merchant operating a portable business may also use a mobile device, such as a smart phone, but a merchant having a fixed place of business may alternatively use a stationary computing device, such as a suitably programmed PC, although a mobile device, such as a tablet or smart phone, might nevertheless be used in such a fixed place of business. In any event, for the purpose of this example, it will be assumed that the merchant device is located in a place of business of the merchant.

Step 100 of the method involves establishing a wireless communication connection between the client device and the merchant device in accordance with a prior association of the client device and the merchant device. Accordingly, it will be appreciated that the client device and the merchant device should each have suitable wireless communication capabilities for allowing the wireless communication connection to be established. This initial step may occur, for example, when the client device is brought within a suitable wireless communication range of the merchant device after the prior association of the two devices. For instance, the customer may enter the place of business of the merchant, such that the client device (assumed to be carried by the customer as mentioned above) comes within wireless communication range of the merchant device located in the place of business. Preferably, the wireless communication connection will be established automatically once the two devices are brought within a suitable wireless communication range.

At step 110, a customer order is made. It should be appreciated that the customer order may take a variety of different forms and may be made at different stages in relation to the supply or consumption of goods and/or services. For example, the customer order could be made to purchase a product for which payment is required before the product is supplied to the customer. Alternatively, the customer order could be made to purchase food and/or or beverages which are consumed at the place of business before payment is required. In any event, the customer order will require a payment from the customer to the merchant to complete a particular business transaction.

In response to the customer order, at step 120, the merchant device generates a payment request in accordance with the wireless communication connection. In general, the payment request will include at least a payment amount required for the customer order, and may optionally additionally include a payment description or other more detailed information regarding the customer order.

The following step 130 involves determining whether the payment request is in accordance with pre-approved payment parameters associated with the merchant. This may involve comparing the payment amount and potentially other information included in the payment request against the pre-approved payment parameters, which are typically set by the customer. For example, the pre-approved payment parameters may be set so that only payment amounts equal to or lower than a predetermined payment limit are pre-approved for that particular merchant. Further examples of suitable pre-approved payment parameters will be provided in due course.

In response to a successful determination in the above step 130, then a payment from a payment instrument of the customer to an account of the merchant will be approved in accordance with the payment request at step 140, without requiring any customer interaction with the client device. Accordingly, the customer will be able enter the merchant's place of business, make a customer order and have the payment automatically approved, provided the customer is carrying a client device that has a prior association with the merchant device (such that the wireless communication connection may be established) and the payment request satisfies the pre-approved payment parameters. This can all occur whilst the client device remains in its carried location, such as in a pocket or bag of the user.

However, if it is found at step 130 that the payment request is not in accordance with the pre-approved payment parameters, manual approval may be required at step 150. Thus, a payment request exceeding a predetermined payment limit or otherwise not satisfying other pre-approved payment parameters will not be automatically approved under this method. Usually the customer will be notified of this outcome, such as by verbal notification by the merchant and/or by electronic notification using the client device. In the event that manual approval is requested, the customer will still have an opportunity to approve the payment and thus override the pre-approved payment parameters.

It will be appreciated that the above described method may be used to reduce friction in payments between a customer and a trusted merchant with whom the customer regularly makes purchases. Assuming the pre-approved payment parameters are met for the particular payment request, the method may facilitate invisible payments from the payment instrument of the customer to the account of the merchant. The customer's purchasing experience will be significantly streamlined by essentially avoiding the need for the customer to play an active part in the payment process. Nevertheless, the customer can be reassured that payments with a particular merchant will only be processed within pre-approved limits, allowing the customer to exercise control over their expenses with the merchant.

Although this method may facilitate invisible payments between a customer and a trusted merchant, it should be noted that the method does not rely solely on a trusting relationship between the customer and the merchant, since the method includes specific features for maintaining payment security and customer authentication.

As mentioned above, the merchant device generates a payment request in accordance with the wireless communication connection, and it will be appreciated that this provides security against automatic payments being performed when the client device is not present. This can prevent abuse by merchants or other individuals. By making the generation of the payment request dependent on the presence of the wireless communication connection between the client device and the merchant device, this effectively confirms that the client device (and assumedly the customer that carries the device) is in the vicinity of the merchant device. As mentioned above, in this example, the merchant device is assumed to be located in the merchant's place of business, such that the reliance on the wireless communication connection will ensure that a payment request is only generated when a client device is in the merchant's place of business when a customer order is made.

Whilst there is still the possibility that a person other than the owner of the client device may obtain the client device and attempt to make automatic payments with the customer's account using the client device, it should be understood that the magnitude of potentially available unauthorised payments will be limited to the pre-approved payment parameters set by the customer. Furthermore, automatic payments can only be made with particular trusted merchants for whom the customer has set such pre-approved payment parameters, the identities of which may be unknown to the person. Therefore the potential for abuse of this method by thieves will be relatively minor. As will be described in further detail in due course, the method may also involve requiring the merchant to confirm the presence of the customer before the payment request is generated, for instance with regard to an image of the customer, as an additional security measure.

Moreover, other safeguards may be implemented for allowing the customer to deactivate any pre-approved payment parameters upon loss or theft of the customer's client device to eliminate the risk of automatic payments being performed. For example, the customer may access configuration settings for the pre-approved payment parameters via a web interface using a different electronic processing device to effectively remotely deactivate pre-approved payments. It is noted that these safeguards will be in addition to the usual security measures that may be employed by a customer in response to loss or theft of a mobile phone, such as remotely disabling the mobile phone or any associated payment instruments.

It will be appreciated that the above described method may be used to provide a system for reducing friction in everyday payments at merchants, while maintaining payment security and user authentication. This may provide an invisible payment solution for merchants, allowing customers to enjoy what they love while payments are processed in the background. Merchants can increase both sales and encourage customer loyalty. Invisible payments, as facilitated by this method, are the next frontier in payment technology, offering frictionless experiences to customers with payments processed in the background and giving the ability to product and service providers to offer a more personal service. This method may be useful not only for physical retail stores and service providers, but also for portable business operators due to the use of ubiquitous electronic processing devices.

Further implementation features of the method will now be described.

The above mentioned prior association of the client device and the merchant device may include a wireless communication pairing of the client device and the merchant device. For instance, the wireless communication pairing of the client device and the merchant device may be performed using Bluetooth. In particular, the client device and the merchant device may be previously paired via Bluetooth so that a Bluetooth wireless communication connection is automatically established when the client device and the merchant device are brought within Bluetooth communication range. Further details of the pairing of the devices will be described in an example of an initial configuration of the system in due course.

Whilst Bluetooth provides a particularly suitable wireless communication technology for use in this method due to its common use in mobile devices, it will be appreciated that a range of other wireless communication technologies may be used in this method. For example, Wi-Fi (IEEE 802.11 standard) communication technologies may be used, such as by having the client device automatically establish a connection to the merchant device using a Wi-Fi network. The Wi-Fi Direct standard may be useful in allowing peer-to-peer wireless communication pairing, similar to Bluetooth, without requiring a central Wi-Fi hub or router.

As far as the payment request is concerned, as mentioned above, this will typically include at least a payment amount, but may optionally provide one or more of a merchant identifier, a payment description, an itemized list of the customer order, or any other relevant information regarding the payment. It will be appreciated that the information included in the payment request may be utilized in determining whether the payment request is in accordance with pre-approved payment parameters associated with the merchant. The merchant identifier may be used to rapidly identify the merchant for allowing the appropriate pre-approved payment parameters to be retrieved. In some examples, a payment description or an itemized list of the customer order may be analysed to determine whether the payment relates to pre-approved types of purchases. Otherwise, the payment description may be used to provide further details of the payment for later review by the customer after an automatically approved payment has been performed.

As discussed previously, the method may provide enhanced security by requiring confirmation that the customer associated with the client device is actually present for the transaction. This may involve identifying the customer associated with the client device in accordance with the wireless communication connection, prior to generating the payment request. For instance, the merchant may be responsible for identifying the customer making the customer order to ensure that the customer is indeed the individual associated with the client device that has a wireless communication connection with the merchant device.

In one example implementation, identifying the customer includes the merchant device displaying respective customer indications corresponding to respective client devices having a current wireless communication connection to the merchant device, and the merchant device subsequently obtaining a selection of one of the customer indications based on manual input by the merchant. Having the merchant input a selection of a customer indication in this way provides additional verification that the customer has been sighted by the merchant before allowing the payment request to be generated.

In some examples, the identification of the customer by the merchant may be assisted by providing the merchant with other information regarding the customer. For example, each customer indication may include one or more of a name of the respective customer, and an image associated with the customer. Thus, the merchant may be able to check this other information regarding the customer to confirm the identity of the customer. For example, the image associated with the customer may be a photographic image of the customer's face, such that the merchant can compare the image with the customer's actual face to verify that the customer is indeed the customer corresponding to the client device.

In some specific implementations, the client device may be responsible for transferring a customer indication to the merchant device. The customer indication may be stored on the client device and transferred to the merchant device once the wireless communication connection has been established. In one example, the customer indication may be transferred to the merchant device via the wireless communication connection. For instance, application software executed on the client device may initiate the transfer or stored customer indication information, such as the customer's name and photographic image, directly to the merchant device. However, in alternative examples, at least part of the customer indication may be transferred to the merchant device via the Internet. For instance, the merchant device may simply receive a customer identifier as the customer indication, and this may be used to retrieve stored customer indication information from a central approval server. This stored customer indication information may have been uploaded by the customer at an earlier stage during an initial configuration of the system.

Similarly, the payment request may be transferred from the merchant device in different ways. In one example, the merchant device may be configured to directly transfer the payment request to the client device via the wireless communication connection. In alternative examples, the merchant device may transfer the payment request to an approval server via the Internet such that the approval server transfers the payment request to the client device via the Internet. The client device may be responsible for determining whether the payment request is in accordance with pre-approved payment parameters associated with the merchant.

However, it should be understood that the payment request may not even need to be transferred to the client device at all in some implementations, depending on where it is determined whether the payment request is in accordance with pre-approved payment parameters associated with the merchant. Although this determination may be performed by the client device, in some implementations this may be performed in a central approval server processing system, in which case the payment request may only need to be transferred to the approval server and not the client device. Accordingly, the method may include the merchant device transferring the payment request to an approval server, and the approval server determining whether the payment request is in accordance with pre-approved payment parameters associated with the merchant.

As far as the pre-approved payment parameters are concerned, these may include one or more of an approved maximum single payment amount, an approved daily payment limit, an approved frequency of payments, an approved time of day or specific approved goods or services. It will be appreciated that the customer may set different pre-approved payment parameters for each particular trusted merchant with whom the customer desires to have automatic invisible payments. Examples of how the aforementioned types of pre-approved payment parameters may be used in practice will now be discussed.

The use of an approved maximum single payment amount will involve a straightforward comparison between the payment amount associated with the payment request and the approved maximum single payment. If the payment amount exceeds the approved maximum single payment, then a payment in accordance with the payment request will not be automatically approved. Otherwise, if the payment amount is equal to or less than the approved maximum single payment, then the payment may be automatically approved, provided all other pre-approved payment parameters are satisfied.

An approved daily payment limit may be used to better manage daily spending with a merchant with whom the customer makes frequent purchases. Determining whether the payment request is in accordance with the approved daily payment limit may include accessing stored details of previous payments to the merchant on the same day, calculating a total daily payment amount based on payment amounts for the previous payments and a payment amount for the payment request, and determining whether the total daily payment amount is within the approved daily payment limit. It will be appreciated that this requires details of previous payments to the merchant to be stored. These previous payment details may be stored locally on the client device or centrally by an approval server responsible for managing the pre-approved payment and storing records thereof.

The pre-approved payment parameter or an approved frequency of payments will typically be specified by an approved number of payments in a predetermined time period, such as a day, week or month. Accordingly, determining whether the payment request is in accordance with the approved frequency of payments may include accessing stored details of previous payments to the merchant in the predetermined time period, and determining whether a number of previous payments is less than the approved number of payments. Again, it will be appreciated that this requires details of previous payments to the merchant to be stored as discussed above.

The use of an approved time of day may involve comparison of a time the payment request was issued or received against the approved time of day. The approved time of day may be in the form of a time window specified by the customer, such as 8 am-10 am. If the time of the payment request is outside of the set time window, then the payment will not be automatically approved.

Finally, the use of approved goods or services as a pre-approved payment parameter may permit the customer to only allow particular goods or services to be specified for which automatic payment approval may be allowed. For instance, the customer may specify that only payments for coffee purchases may be pre-approved with a trusted merchant that operates a café. In this case, the payment request may include an itemized list of purchases in the customer order and these may be compared against the approved goods or services to determine if any of the purchases are not pre-approved, in which case the payment will not be automatically approved.

In the event that the payment request is determined to be in accordance with approved payment parameters, such that the payment is automatically approved, the method may further involve causing the payment to be performed in accordance with the payment request using one of a payment instrument token stored in a mobile wallet of the customer or a payment instrument token stored by the merchant. Accordingly, implementations of the method will typically require that the customer have a mobile wallet (provided, for example, by a card scheme, payment instrument issuer, mobile network, smartphone vendor or the like) or a card-on-file (COF) with the particular merchant. Payment instrument details (such as primary account number (PAN), expiry date, and card verification value (CVV) for a credit/debit card) will generally be stored in the wallet or COF system. Payment instrument information should be stored in tokenized form on the merchant or payment service provider (PSP) platform, as per known mobile payment systems. An exemplary mobile wallet system is MasterPass® of MasterCard International Incorporated.

On the other hand, in the event that the payment request is not in accordance with approved payment parameters, the method may involve requesting manual authorisation of the payment request by the customer using the client device, as mentioned above.

In view of the above, it will be appreciated that a suitable system for approving a payment from a customer to a merchant will include a client device of the customer and a merchant device of the merchant. The system will be configured to have the client device and the merchant device establish a wireless communication connection in accordance with a prior association of the client device and the merchant device. Then in response to a customer order, the merchant device will generate a payment request in accordance with the wireless communication connection. Finally, the system will be configured to determine whether the payment request is in accordance with pre-approved payment parameters associated with the merchant, and in response to a successful determination, automatically approve a payment from a payment instrument of the customer to an account of the merchant in accordance with the payment request, without requiring any customer interaction with the client device.

From the perspective of the merchant device, an example implementation of the method may involve the following steps. The merchant device may establish a wireless communication connection with a client device of the customer in accordance with a prior association of the client device and the merchant device. Then, in response to a customer order, the merchant device may generate a payment request in accordance with the wireless communication connection. Following this, the merchant device may transfer the payment request to an approval server that determines whether the payment request is in accordance with pre-approved payment parameters associated with the merchant, and in response to a successful determination, automatically approves a payment from a payment instrument of the customer to an account of the merchant in accordance with the payment request, without requiring any customer interaction with the client device. Finally, the merchant device receives a successful payment notification from the approval server. It will be appreciated that this example assumes that an approval server performs the determination, although as mentioned above, alternative implementations may not necessarily require an approval server.

In any event, assuming the approval server is used, the above mentioned example implementation may involve the following steps from the approval server perspective. The approval server may receive, from a merchant device of the merchant, a payment request generated by the merchant device in response to a customer order and in accordance with a wireless communication connection established between a client device of the client and the merchant device in accordance with a prior association of the client device and the merchant device. Following this, the approval server may determine whether the payment request is in accordance with pre-approved payment parameters associated with the merchant, and in response to a successful determination, automatically approve a payment from a payment instrument of the customer to an account of the merchant in accordance with the payment request, without requiring any customer interaction with the client device.

As mentioned, the approval server may not be needed, and in some alternative implementations the determination may be performed locally in the client device. In one example, the method may involve the following steps from the perspective of the client device. The client device may establish a wireless communication connection with a merchant device of the merchant in accordance with a prior association of the client device and the merchant device. Then, the client device may receive, from a merchant device of the merchant, a payment request generated by the merchant device in response to a customer order and in accordance with the communication connection. Subsequently, the client device may determine whether the payment request is in accordance with pre-approved payment parameters associated with the merchant, and in response to a successful determination, automatically approving a payment from a payment instrument of the customer to an account of the merchant in accordance with the payment request, without requiring any customer interaction with the client device.

As mentioned in the above discussion of the method, implementations of the system may further include an approval server configured to receive the payment request and determine whether the payment request is in accordance with pre-approved payment parameters associated with the merchant. The approval server may be configured to cause the payment to be performed by communicating with a payment server. The payment server may be a payment gateway server, a digital wallet server, or other server or computer system capable of receiving payment credentials and passing them (typically in encrypted and/or tokenized form) as part of a payment authorisation request to a payment network, such as that operated by MasterCard International Incorporated.

It will be appreciated that since the above described method depends on a prior association of the client device and the merchant device along with pre-approved payment parameters for the merchant, it will be necessary to provide functionalities for establishing such a prior association and allowing the pre-approved payment parameters to be specified.

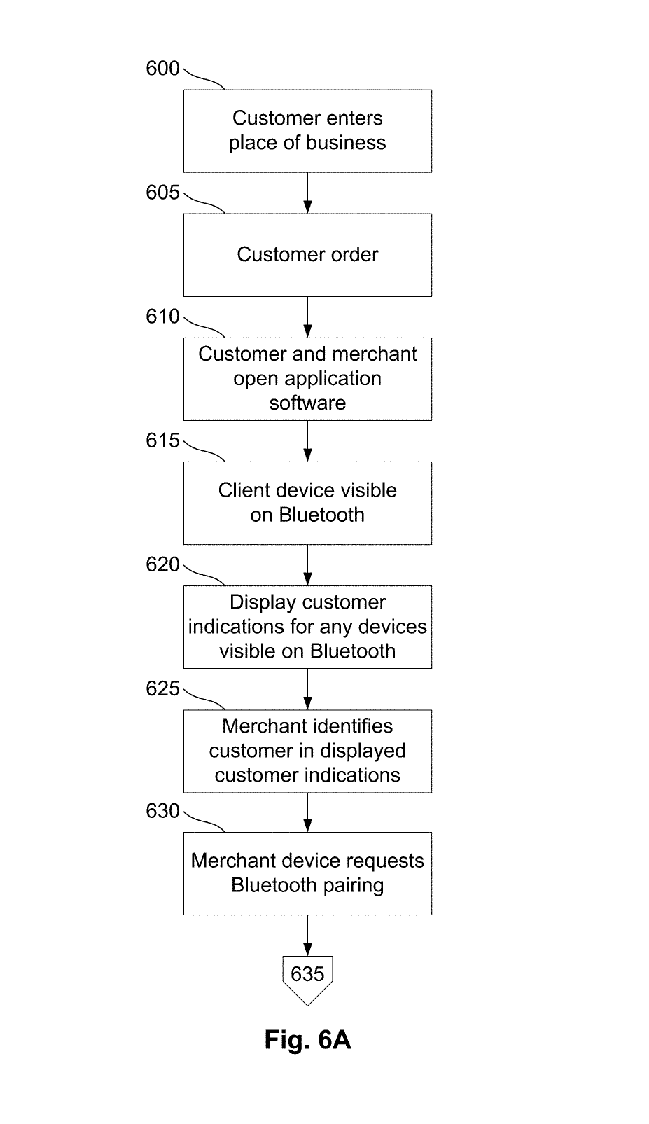

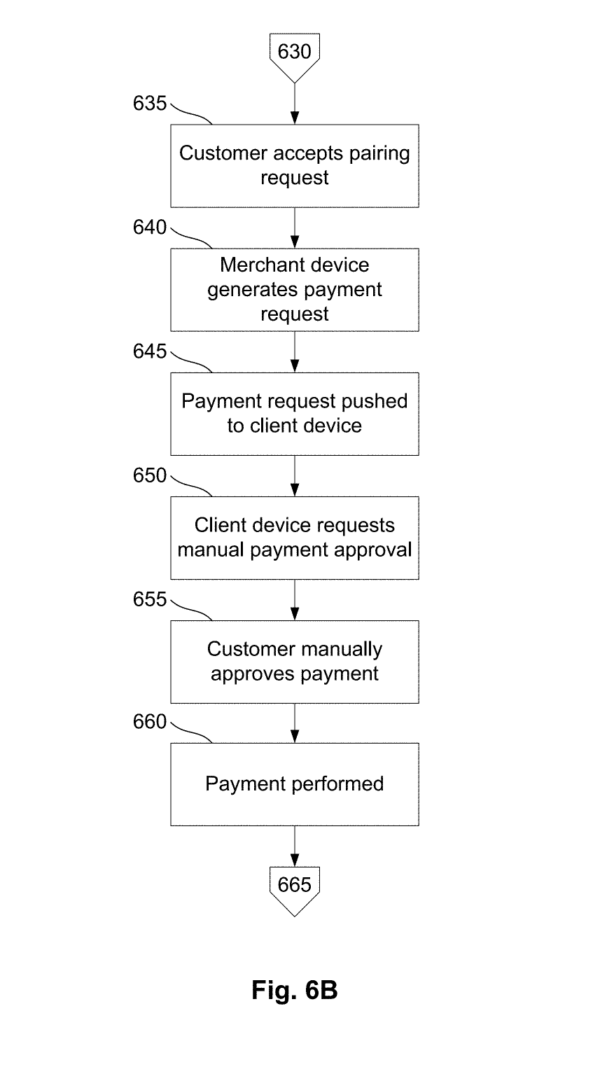

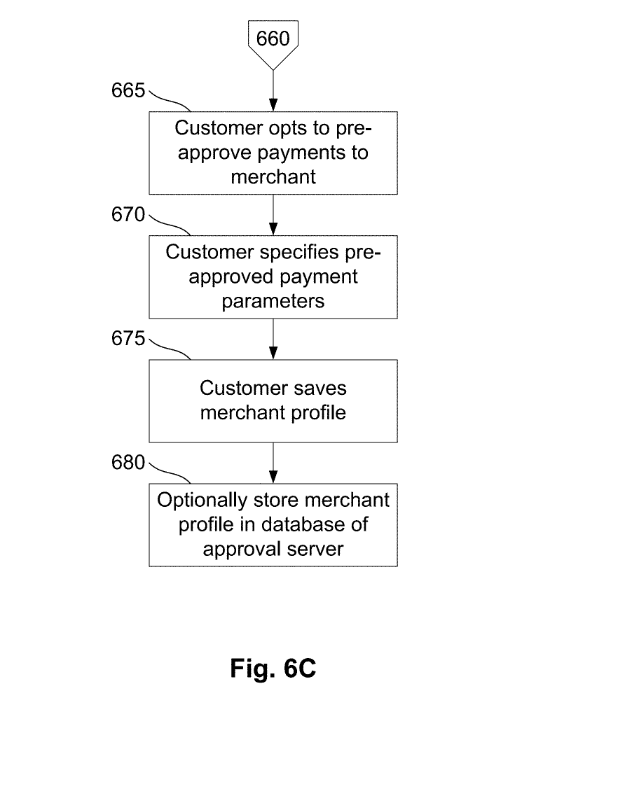

Accordingly, a method may also be provided for configuring pre-approved payments from a customer to a merchant. This method may also be performed using a client device of the customer and a merchant device of the merchant, and may include steps of associating the client device and the merchant device to allow a wireless communication connection to be established between the client device and the merchant device, determining a customer selection of pre-approved payment parameters associated with the merchant, storing the pre-approved payment parameters in a merchant profile to thereby allow payments to be made from a payment instrument of the customer to an account of the merchant in accordance with the pre-approved payment parameters associated with the merchant. A detailed example of this process will be described in due course with regard to FIGS. 6A to 6C.

The functionalities described above may be implemented using application software executed by the client device and merchant device. In some examples, the client device will execute application software configured for enabling payments to be automatically approved for a number of different participating merchants, although in other examples dedicated application software may be provided for a single merchant. The merchant device will also execute application software for enabling merchant-side functionalities. It will be appreciated that the functionalities required for the merchant device will usually differ from the client device by a sufficient amount to justify a different merchant version of the application software compared to the client version of the application software. In some implementations, the merchant version of the application software may be configured to replace or supplement the merchant's point-of-sale platform. In one example, the merchant device may execute point-of-sale application software integrating all of the required functionalities for enabling the above discussed method from the merchant perspective.

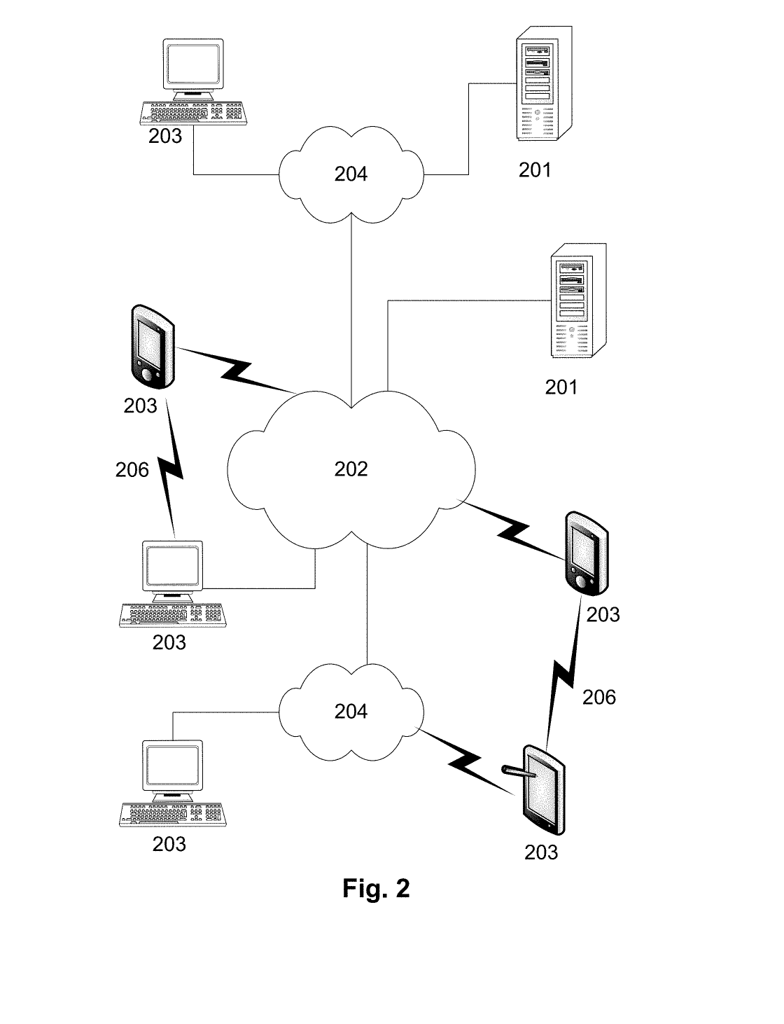

In one example, the process is performed by one or more processing systems operating as part of a distributed architecture, an example of which will now be described with reference to FIG. 2.

In this example, the arrangement includes a number of processing systems 201, 203 interconnected via one or more communications networks, such as the Internet 202, and/or a number of local area networks (LANs) 204. It will be appreciated that the configuration of the networks 202, 204 are for the purpose of example only, and in practice the processing systems 201, 203 can communicate via any appropriate mechanism, such as via wired or wireless connections, including, but not limited to mobile networks, private networks, such as an 802.11 networks, the Internet, LANs, WANs, or the like, as well as via direct or point-to-point wireless communication connections 206, such as Bluetooth, Wi-Fi Direct, or the like.

The nature of the processing systems 201, 203 and their functionality will vary depending on their particular requirements. In one particular example, the processing systems 201, 203 represent servers and clients, although this is not essential and is used primarily for the purpose of illustration.

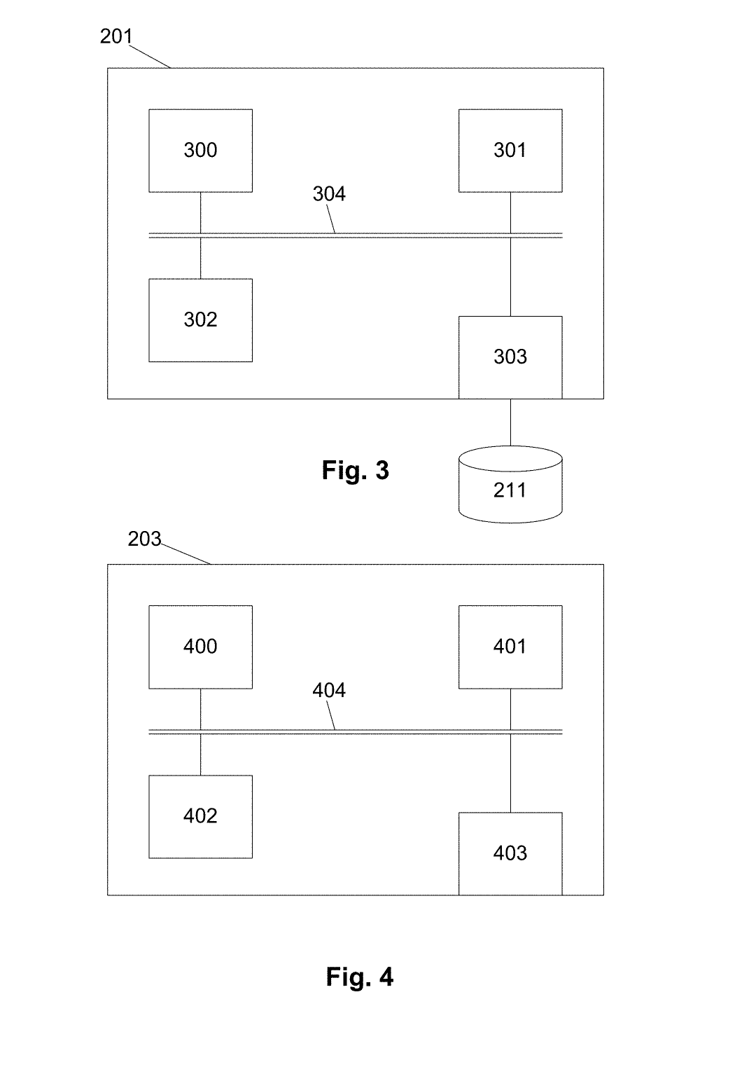

An example of a suitable processing system 201 is shown in FIG. 3. In this example, the processing system 201 includes an electronic processing device, such as at least one microprocessor 300, a memory 301, an optional input/output device 302, such as a keyboard and/or display, and an external interface 303, interconnected via a bus 304 as shown. In this example the external interface 303 can be utilized for connecting the processing system 201 to peripheral devices, such as the communications networks 202, 204, databases 211, other storage devices, or the like. Although a single external interface 303 is shown, this is for the purpose of example only, and in practice multiple interfaces using various methods (e.g. Ethernet, serial, USB, wireless or the like) may be provided.

In use, the microprocessor 300 executes instructions in the form of applications software stored in the memory 301 to perform required processes, such as communicating with other processing systems 201, 203. Thus, actions performed by a processing system 201 are performed by the processor 300 in accordance with instructions stored as applications software in the memory 301 and/or input commands received via the I/O device 302, or commands received from other processing systems 201, 203. The applications software may include one or more software modules, and may be executed in a suitable execution environment, such as an operating system environment, or the like.

Accordingly, it will be appreciated that the processing systems 201 may be formed from any suitable processing system, such as a suitably programmed computer system, PC, web server, network server, or the like. In one particular example, the processing system 201 is a standard processing system, such as a 32-bit or 64-bit Intel Architecture based processing system, which executes software applications stored on non-volatile (e.g., hard disk) storage, although this is not essential. However, it will also be understood that the processing systems 201 could be or could include any electronic processing device, such as a microprocessor, microchip processor, logic gate configuration, firmware optionally associated with implementing logic, such as an FPGA (Field Programmable Gate Array), or any other electronic device, system or arrangement.

As shown in FIG. 4, in one example, the processing systems 203 includes an electronic processing device, such as at least one microprocessor 400, a memory 401, an input/output device 402, such as a keyboard and/or display, and an external interface 403, interconnected via a bus 404, as shown. In this example the external interface 403 can be utilized for connecting the processing system 203 to peripheral devices, such as the communications networks 202, 204, wireless communication connections 206, databases, other storage devices, or the like. Although a single external interface 403 is shown, this is for the purpose of example only, and in practice multiple interfaces using various methods (e.g. Ethernet, serial, USB, wireless or the like) may be provided.

In use, the microprocessor 400 executes instructions in the form of applications software stored in the memory 401 to perform required processes, for example, to allow communication with other processing systems 201, 203. Thus, actions performed by processing system 203 are performed by the processor 401 in accordance with instructions stored as applications software in the memory 402 and/or input commands received from a user via the I/O device 403. The applications software may include one or more software modules, and may be executed in a suitable execution environment, such as an operating system environment, or the like.

Accordingly, it will be appreciated that the processing systems 203 may be formed from any suitable processing system, such as a suitably programmed PC, Internet terminal, lap-top, hand-held PC, smart phone, PDA, tablet, or the like. Thus, in one example, the processing system 203 is a standard processing system, such as a 32-bit or 64-bit Intel Architecture based processing system, which executes software applications stored on non-volatile (e.g., hard disk) storage, although this is not essential. However, it will also be understood that the processing systems 203 can be any electronic processing device, such as a microprocessor, microchip processor, logic gate configuration, firmware optionally associated with implementing logic, such as an FPGA (Field Programmable Gate Array), or any other electronic device, system or arrangement.

It will also be noted that whilst the processing systems 201, 203 are shown as single entities, it will be appreciated that this is not essential, and instead one or more of the processing systems 201, 203 can be distributed over geographically separate locations, for example, by using processing systems provided as part of a cloud based environment.

For the purpose of the following detailed examples, it is assumed that the client devices carried by the customers and the merchant devices operated by the merchants will each be provided by processing systems 203 executing suitable application software and capable of establishing wireless communication connections 206 therebetween, as indicated in FIG. 2.

The process may be administered by one or more of the processing systems 201, acting as approval servers, although it should be noted that some implementations of the method may not necessarily require any approval servers. Other processing systems 201 may act as payment servers operated by payment service providers, financial institutions, or the like. The payment servers will be responsible for actually performing the payments in a conventional manner, once the payments have been approved in accordance with the method.

As depicted in FIG. 2, the processing systems 201 acting as approval servers and/or payment servers and processing systems 203 acting as client devices and merchant devices may be connected to communications networks 202, 204 in different configurations, to allow communication between the different processing systems 201, 203 via the Internet 202.

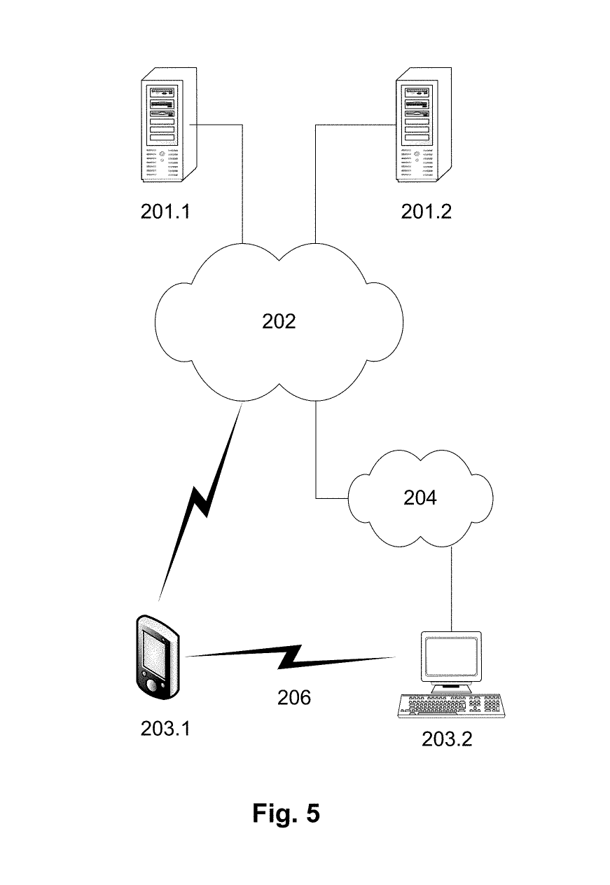

A particular example of a system configuration for approving a payment from the customer to the merchant, which is assumed to be used in the following detailed examples, will now be described with regard to FIG. 5.

In this example, the customer carries a client device 203.1 in the form of a smartphone and the merchant operates a merchant device 203.2 in the form of a point-of-sale terminal located in a place of business of the merchant. Both the client device 203.1 and the merchant device 203.2 are capable of establishing a wireless communication connection 206 with other devices that are within wireless communication range. In this example, the wireless communication connection 206 is assumed to be established using Bluetooth. Typically the client device 203.1 and the merchant device 203.2 will also be configured to connect to the Internet. In this case the client device 203.1 wirelessly connects to the Internet and has a data plan on a mobile network for allowing the consumption of mobile data via the Internet, whilst the merchant device 203.2 is wirelessly connected to a local area network 204 which is in turn connected to the Internet 202.

Each of the client device 203.1 and the merchant device 203.2 will typically execute application software for enabling the functionalities required to perform the method. The customer and the merchant will interact with their respective client device 203.1 and the merchant device 203.2 using the application software as follows.

The customer interacts with the client device 203.1 to initially establish an association of the client device 203.1 and the merchant device 203.2 for allowing the wireless communication connection 206 to be automatically established at later times whenever the client device 203.1 and the merchant device 203.2 come within wireless communication range, without requiring any user interaction. The customer also interacts with the client device 203.1 to perform other tasks, such as initially configuring pre-approved payment parameters for a merchant, revising pre-approved payment parameters at a later time as required, manually approving payments that do not satisfy pre-approved payment parameters, and reviewing details of previous payments.

The merchant interacts with the merchant device 203.2 to initially establish the aforementioned association of the client device 203.1, and also interacts with the merchant device 203.2 to perform other tasks, such as generating payment requests for customer orders, identifying customers associated with client devices 203.1, and potentially performing other point-of-sale functionalities outside the scope of this application.

In this example, the system includes an approval server 201.1 which may be configured to send and receive information to and from the client device 203.1 and the merchant device 203.2 to administer the payment approval process. However, it should be appreciated that an approval server 201.1 may not be required in some implementations. In any event, the client device 203.1 and the merchant device 203.2 will usually be connected to the approval server 201.1 via the Internet.

The client device 203.1 may transfer pre-approved payment parameters to the approval server 201.1 so that these can be centrally stored. The merchant device 203.2 may transfer payment requests to the approval server 201.1 so that these either can be processed to centrally determine whether the payment request is in accordance with stored pre-approved payment parameters, or transferred on to the client device 203.1 to allow the determination to be made by the client device 203.1. The application software executed by each of the client device 203.1 and merchant device 203.2 will typically be configured to facilitate these and other information transfers. The customer or merchant may interact with the approval server 201.1 via a GUI (Graphical User Interface), or the like, presented on their respective processing systems 203, such as via the application software or optionally via a browser application that displays webpages hosted by the approval server 201.1.

Depending on where the actual payment approval takes place and the payment instrument being used, at least one of the client device 203.1, the merchant device 203.2 and the approval server 201.1 may communicate with a payment server 201.2 operated by a payment service provider, or the like, to actually cause the payment to be performed after it has been automatically approved in accordance with the method. This communication will typically also be achieved via the Internet.

However, it will be appreciated that the above described configuration assumed for the purpose of the following examples is not essential, and numerous other configurations may be used. It will also be appreciated that the partitioning of functionality between the processing systems 201, 203 may vary, depending on the particular implementation.

An example of a method for a customer configuring pre-approved payments with a merchant in the merchant's place of business will now be described with regard to the flow chart of FIGS. 6A to 6C. It will be appreciated that such a method will typically be carried out as a first-time setup procedure when a customer wishes to reduce friction in their regular payments with a particular merchant.

This example assumes the system configuration, as shown in FIG. 5, with the customer's client device 203.1 having a data plan for consumption of mobile data and both the client device 203.1 and the merchant device 203.2 having suitable versions of the application software for facilitating the process installed. The customer is assumed to be already registered as a user of the application software, and is also assumed to have a mobile wallet containing one or more tokenized payment instruments (credit cards, debit cards, prepaid cards, and/or gift cards, for example) as discussed earlier. Typically, when the customer initially registers as a user, the customer will set up the application software by connecting their tokenized mobile wallet to the application software in preparation for future payments.

In step 600, the customer enters the merchant's place of business and avails themselves of a product or service for which the merchant needs to charge the customer, for example, the customer's regular coffee shop for morning coffee. The customer makes a customer order in step 605 and details of the customer order may be entered into the merchant device 203.2 using conventional techniques.

In step 610, both the customer and the merchant will open the application software on their respective client device 203.1 and merchant device 203.2 to set up automatic payments. The customer ensures the client device 203.1 is set to visible using Bluetooth at step 615.

In the following step 620, the merchant device 203.2 displays customer indications for any devices that are currently visible on Bluetooth. In one example, this may involve having the application software running on the merchant device 203.2 scan for visible devices via Bluetooth, and obtain device identifiers for any visible devices. These device identifiers may be then transferred to the approval server 201.1 with a request for customer indications for any device identifiers associated with registered users of the application software. Customer indications may then be returned from the approval server 201.1 to the merchant device 203.1 to allow these to be displayed. The customer indications will preferably include a name and/or a profile image (usually a photograph of the customer's face) for each registered user. Since the customer is already a registered user and has their client device 203.1 set to visible on Bluetooth, at least a customer indication for the customer should be included in the customer indications displayed on the merchant device 203.2.

In step 625, the merchant identifies the customer in the displayed customer indications. Typically, the customer will be identified based on the customer's name and/or profile image. For instance, if the customer is a regular customer of the merchant, the name of the customer may already be familiar to the merchant in which case the merchant may be able to select the customer indication associated with the customer based on the customer's name alone. However, the use of a profile image may be more convenient for allowing the merchant to select a customer indication for a less familiar customer, by matching the profile image with the customer. The merchant will usually identify the customer by inputting a selection of one of the displayed customer indications, via the merchant device 203.2.

Upon making the selection, the merchant device 203.2 will request pairing between merchant app and customer app via Bluetooth at step 630. Assuming the correct customer has been successfully identified by the merchant, the client device 203.1 will receive the pairing request and the customer accepts the pairing request at step 635. The client device 203.1 and the merchant device 203.2 will then be paired by Bluetooth, thereby establishing an association of the client device 203.1 and the merchant device 203.2 as required for later automatic approvals of payments. When the devices are paired this will also establish a wireless communication connection between the client device 203.1 and the merchant device 203.2.

At step 640, the merchant device 203.2 generates a payment request for the customer order. This will typically include at least the payment amount and usually some additional information, such as a payment description. The payment request is pushed to the client device 203.2 via the application software at step 645. The communication mechanism used to achieve this can involve direct transfer of the payment request via the Bluetooth wireless communication connection, or transfer via the Internet 204. In the latter case, the payment request may be transferred from the merchant device 203.2 to the approval server 201.1 via an Internet connection from the merchant's local area network 202, and the approval server 201.1 may subsequently relay the payment request to the client device 203.1 via a mobile Internet connection.

In any event, the client device 203.1 will receive the payment request following step 645. Since pre-approved payments have not yet been configured by the customer for this particular merchant, the customer is prompted to manually approve the payment at step 650. At step 655, the customer approves the payment in accordance with the payment request using the application software. Typically this step will also include authentication of the customer's identity using a personal identification number (PIN), biometric identification (such as a fingerprint scan), or the like.

Once this approval has been given, at step 660 a payment from a payment instrument of the customer to an account of the merchant can be performed in accordance with the payment request, using conventional techniques. For instance, when the customer has a mobile wallet, the application software may cause a payment to be performed using a payment instrument associated with the mobile wallet, by communicating with a payment server 201.2 operated by a respective payment service provider or financial institution. This communication with the payment server 201.2 may be facilitated by the approval server 201.1 in some implementations.

After successful payment for the current customer order, the customer now has the option to approve the merchant as a trusted merchant for regular invisible payments using the above described method. At step 665, the customer opts to pre-approve payments to the merchant, using the client device 203.1.

The customer can then specify desired pre-approved payment parameters at step 670. For instance, the customer can specify a maximum amount that can be transacted from that particular merchant per day. The customer can also specify a time of day and frequency under which transactions can be accepted “invisibly”. For example, for a coffee shop, the maximum amount per transaction may be $10, time of day may be 8 am-10 am, and frequency may be 1× per day.

At step 675, the customer saves a merchant profile for the particular merchant, including invisible payment restrictions. The saved merchant profile may optionally be transferred to the approval server 201.1 at step 680 to allow this to be stored centrally in a database of the approval server 201.1.

In some implementations, the customer may be allowed to interact with the approval server 201.1 via a web interface using any suitable Internet connected device, to thereby modify the merchant profile without needing to use the client device 203.1. The merchant profile can be synchronised between the approval server 201.1 and the client device 203.1 to ensure that the current version of the merchant profile is used at all times. It will be appreciated that appropriate security methods should be implemented to ensure that only the registered customer is able to log in to the approval server 201.1 to modify merchant profiles.

The customer may also be given the option to rank the merchant's trustworthiness as part of the merchant profile. This ranking can be displayed to other users to guide their decisions when trusting merchants for invisible payments by aggregating a ranking.

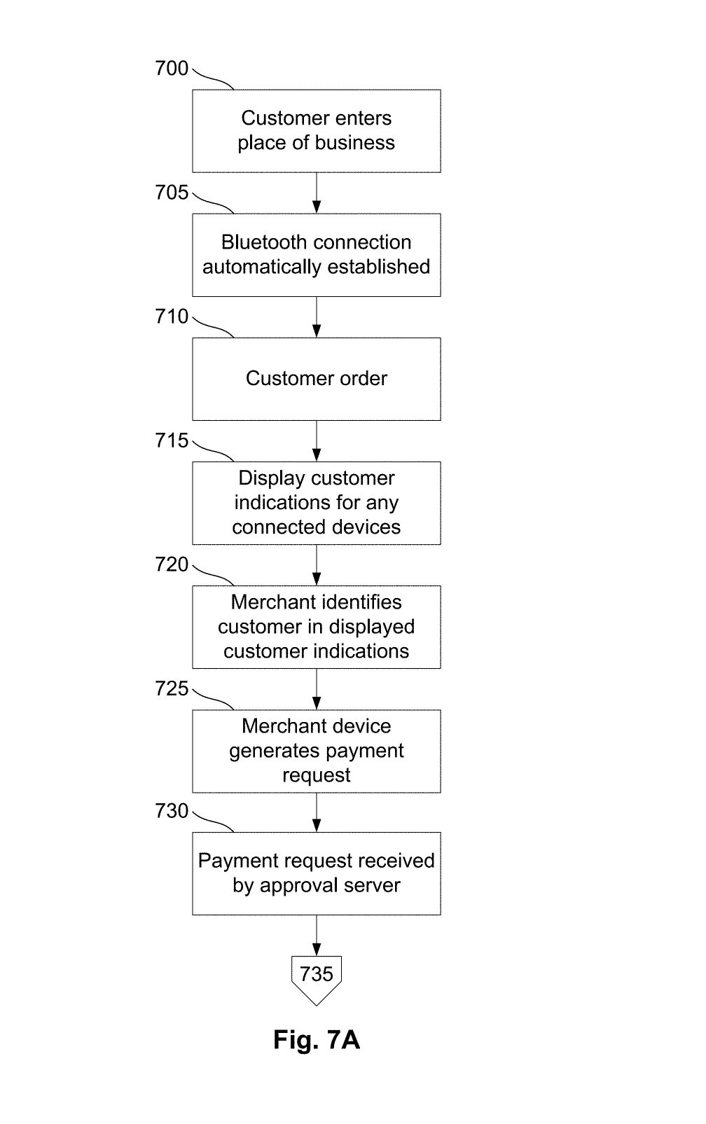

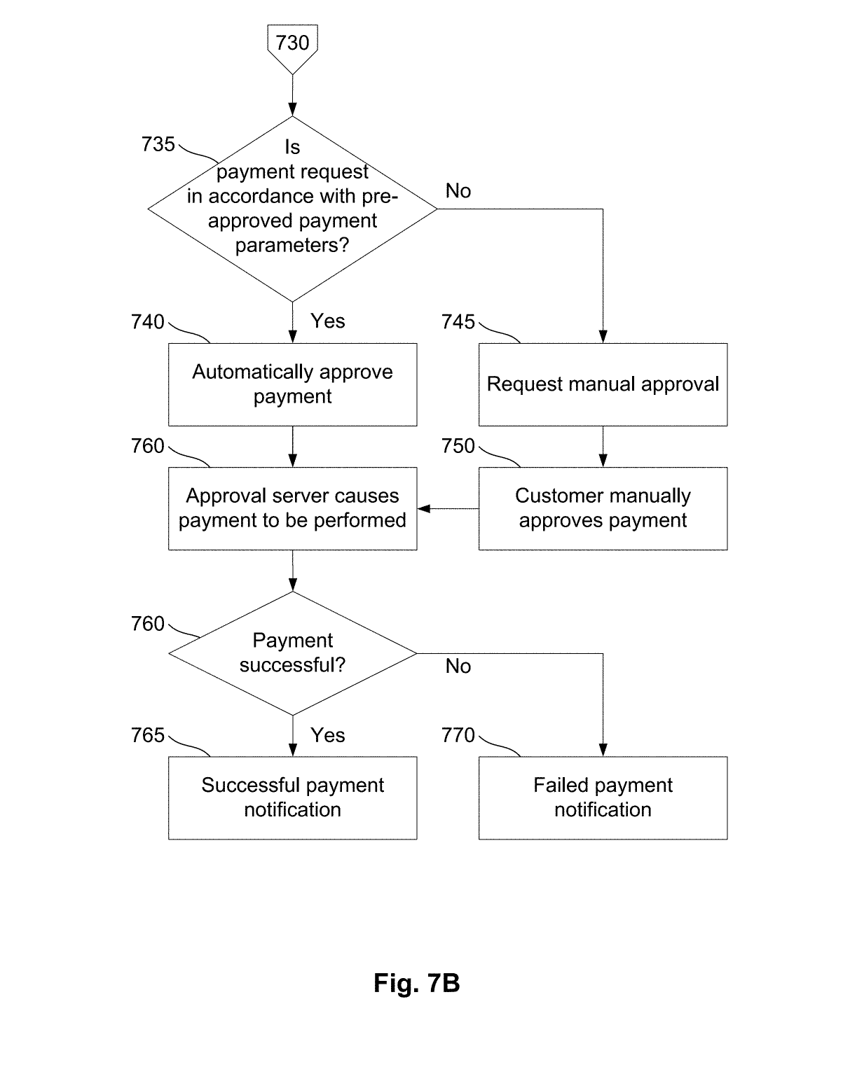

An example of a method for automatically approving a payment in the merchant's place of business will now be described with regard to the flow chart of FIGS. 7A and 7B. This method once again assumes the use of a system configuration as depicted in FIG. 5 and also assumes that the customer has already configured pre-approved payments with the merchant in a suitable manner as exemplified above with regard to FIGS. 6A to 6C. Accordingly, it is assumed that there is a prior association of the client device 203.1 and the merchant device 203.2 in the form of a Bluetooth pairing, and the customer has already specified pre-approved payment parameters for the merchant and these have been saved in a merchant profile.

In step 700, the customer will once again enter the place of business of the merchant and may avail themselves of the products or services available. On this subsequent visit to the place of business by the customer, a Bluetooth wireless communication connection between the client device 203.1 and the merchant device 203.2 will be automatically established at step 705, in accordance with the prior Bluetooth pairing. It will be appreciated that this Bluetooth connection will require the client device 203.1 and the merchant device 203.2 to be within Bluetooth range, and therefore in a large retail store the Bluetooth connection may only be established once the customer has moved sufficiently close to the merchant device 203.2, for instance by approaching a sales counter to make a purchase.

The customer will then make a customer order at step 710. At this stage, the merchant may be required to identify the customer in a similar manner as discussed above for the initial configuration. In this instance, the merchant device 203.2 will display customer indications for any connected client devices 203.1 at step 715. It will usually be convenient to display customer indications for any currently connected client devices 203.1 alongside customer indications for any other client devices 203.1 that are visible on Bluetooth. The display of customer indications may distinguish between client devices 203.1 that are currently connected and those that are only visible to aid in the merchant's identification of the customer.

At step 720, the merchant then interacts with the application software running on the merchant device 203.2 to select a customer indication corresponding to the customer making the customer order, to thereby identify the customer. As described previously with respect to steps 620 and 625 of the previous example, the merchant may use the customer's name and/or profile image to identify the customer. The customer indications can once again be supplied from the approval server 201.1 via the internet, or may alternatively be transferred directly from the client device 203.1 to the merchant device 203.2 via the Bluetooth connection.

Once the merchant has identified the customer, this can be taken as verification that the owner of the client device 203.1 is present. This can also ensure that the payment will be requested from the correct customer in the event that multiple client devices 203.1 are currently connected to the merchant device 203.2.

At step 725, the merchant device 203.2 generates a payment request in a similar fashion as described above for step 640 in the previous example. Depending on the particular implementation of the system, the payment request may be transferred to either the client device 203.2 or the approval server 201.1 for further processing. In this example, it is assumed that the payment request is received by the approval server 201.1 at step 730, such that the approval server 201.1 will be responsible for determining whether the payment request is in accordance with pre-approved payment parameters for the merchant at step 735.

However, it should be appreciated that, in an alternative example, the payment request may be pushed to the client device 203.2 at this stage. This may be achieved either via a direct Bluetooth transfer or via the Internet as described above with regard to step 645. Then the client device 203.2 may perform the determination as to whether the payment request is in accordance with pre-approved payment parameters for the merchant.

In any event, the determination at step 735 will involve comparison of the payment request against any pre-approved payment parameters that have been specified by the customer and saved in a merchant profile for the particular merchant. Assuming that the amount, time of day, and frequency parameters are all acceptable in view of the pre-approved payment parameters, the payment will be automatically approved at step 740, without requiring any customer interaction with the client device 203.1. No further authentication from the customer is required.

However, if any of the pre-approved payment parameters are not satisfied at step 735, manual approval of the payment may be requested at step 745. In other words, in the event that a payment is requested by the merchant that exceeds the pre-approved payment parameters, the user will need to manually approve the payment, usually with further authentication being required via the application software using PIN/password/biometric or other authentication measures.

The request for manual approval may involve causing the client device 203.1 to emit an alert tone and/or vibration feedback to prompt the customer to check the client device 203.1 and manually approve the payment using the client device 203.1. Alternatively or additionally, the merchant device 203.2 may receive a notification that the pre-approved payment parameters were not satisfied, to thereby prompt the merchant to inform the customer that the payment was not automatically approved and that manual approval will be required. If the customer wishes to nevertheless proceed with the purchase, the customer may approve the payment at step 750.

Whether the payment is automatically approved at step 740 or manually approved at step 750, the approval server 201.1 will usually be responsible for causing the payment to be performed from the payment instrument tokenized and on file with the customer's account at step 755. The approval server 201.1 may communicate with a payment server 201.2 to trigger the payment. If the determination of whether the payment request is in accordance with the pre-approved payment parameters is performed centrally by the approval server 201.1 and the payment is automatically approved, the payment may be triggered without requiring any further data transfers to/from the client device 203.1 and the merchant device 203.2.

On the other hand, if the payment is manually approved using the client device 203.1, an approval indication will be transferred from the client device 203.1 to the approval server 201.1 so that the approval sever 201.1 can trigger the payment. Similarly, if the determination of whether the payment request is in accordance with the pre-approved payment parameters is performed by the client device 203.1 and the payment is automatically approved, an approval indication may be transferred from the client device 203.1 to the approval server 201.1.

It should be noted that in some alternative implementations, the customer may have a card-on-file with the merchant instead of a mobile wallet. In this case, once the payment has been automatically approved at step 740 (or manually approved at step 750), an approval indication may be provided to the merchant device 203.2 and the merchant device 203.2 may then cause the payment to be performed using the card-on-file details. This form of payment could also be facilitated through a payment server 201.2 operated by a payment service provider.

In any event, at step 760 a determination will be made as to whether the payment is successful, and if the payment is indeed successful, a successful payment notification will be provided to the client device 203.1 and the merchant device 203.2 at step 765. The successful payment notification may be stored on the client device 203.1 and optionally on the approval server 201.1 to provide the ability for the customer to review any automatic payments that have been made.

The customer will be given the option to dispute payments via the application software for easy resolution of questionable transactions. The customer will also be able to “untrust” a merchant and deactivate invisible payments, if desired, which will also impact the merchant's trust ranking displayed to other potential and current customers.

On the other hand, if the payment is unsuccessful at step 760, a failed payment notification may be provided at step 770, which may prompt the customer to attempt the payment using alternative techniques or to cancel the transaction (if possible).

In view of the above, it will be appreciated that the above discussed techniques can facilitate the automatic approval of payments with merchants provided these satisfy pre-approved payment parameters, thus enabling effectively invisible payments with trusted merchants that a customer frequents regularly. Whilst these techniques remove friction from the payment process, they maintain payment security by requiring that a wireless communication connection is established in accordance with a prior association of the client device 203.1 and the merchant device 203.2 before a payment request will be generated. Furthermore, the customer can exercise control over their level of expense with the merchant by specifying the pre-approved payment parameters accordingly.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the disclosure broadly appearing before described.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. And again, the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

It should be appreciated that one or more aspects of the present disclosure transform a general-purpose computing device into a special-purpose computing device when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

What is claimed is:

1.-21. (canceled)

22. A method for approving a payment from a customer to a merchant, the method including:
a) establishing, by a merchant device of the merchant, a wireless communication connection with a client device of the customer in accordance with a prior association of the client device and the merchant device;
b) in response to a customer order, generating, by the merchant device, a payment request in accordance with the wireless communication connection;
c) transferring, by the merchant device, the payment request to an approval server that determines whether the payment request is in accordance with pre-approved payment parameters associated with the merchant, and in response to a successful determination, automatically approves a payment from a payment instrument of the customer to an account of the merchant in accordance with the payment request, without requiring any customer interaction with the client device; and
d) receiving, by the merchant device, a successful payment notification from the approval server.

23. The method according to claim 22, wherein the prior association of the client device and the merchant device includes a wireless communication pairing of the client device and the merchant device.

24. The method according to claim 23, wherein the wireless communication pairing of the client device and the merchant device is performed using Bluetooth.

25. The method according to claim 22, wherein the payment request includes a payment amount and at least one of:
a) a merchant identifier;
b) a payment description; and
c) an itemized list of the customer order.

26. The method according to claim 22, wherein the method includes, prior to generating the payment request, identifying, by the merchant device, the customer associated with the client device in accordance with the wireless communication connection.

27. The method according to claim 26, wherein identifying the customer includes:
a) displaying, by the merchant device, respective customer indications corresponding to respective client devices having a current wireless communication connection to the merchant device; and
b) obtaining, by the merchant device, a selection of one of the customer indications based on manual input by the merchant.

28. The method according to claim 27, wherein each customer indication includes at least one of:
a) a name of the respective customer; and
b) an image associated with the customer.

29. The method according to claim 27, wherein the method includes receiving, by the merchant device, the customer indication from the client device.

30. A merchant device for approving a payment from a customer to a merchant, the merchant device being configured to:
a) establish a wireless communication connection with a client device in accordance with a prior association of the client device and the merchant device;
b) in response to a customer order, generate a payment request in accordance with the wireless communication connection;
c) transfer the payment request to an approval server that determines whether the payment request is in accordance with pre-approved payment parameters associated with the merchant, and in response to a successful determination, automatically approves a payment from a payment instrument of the customer to an account of the merchant in accordance with the payment request, without requiring any customer interaction with the client device; and
d) receive a successful payment notification from the approval server.

31. (canceled)

32. A method for approving a payment from a customer to a merchant, the method including:
a) receiving, by the approval server, from a merchant device of the merchant, a payment request generated by the merchant device in response to a customer order and in accordance with a wireless communication connection established between a client device of the client and the merchant device in accordance with a prior association of the client device and the merchant device; and
b) determining, by the approval server, whether the payment request is in accordance with pre-approved payment parameters associated with the merchant, and in response to a successful determination, automatically approving a payment from a payment instrument of the customer to an account of the merchant in accordance with the payment request, without requiring any customer interaction with the client device.

33. The method according to claim 32, wherein the pre-approved payment parameters include at least one of:
a) an approved maximum single payment amount;
b) an approved daily payment limit;
c) an approved frequency of payments;
d) an approved time of day; and
e) approved goods or services.

34. The method according to claim 33, wherein determining whether the payment request is in accordance with the approved daily payment limit includes:
a) accessing stored details of previous payments to the merchant on the same day;
b) calculating a total daily payment amount based on payment amounts for the previous payments and a payment amount for the payment request; and
c) determining whether the total daily payment amount is within the approved daily payment limit.

35. The method according to claim 33, wherein the approved frequency of payments includes an approved number of payments in a predetermined time period, and determining whether the payment request is in accordance with the approved frequency of payments includes:
a) accessing stored details of previous payments to the merchant in the predetermined time period; and
b) determining whether a number of previous payments is less than the approved number of payments.

36. The method according to claim 32, wherein the method includes, responsive to a determination that the payment request is in accordance with approved payment parameters, causing, by the approval server, the payment to be performed in accordance with the payment request using one of:
a) a payment instrument token stored in a mobile wallet of the customer; and
b) a payment instrument token stored by the merchant.

37. The method according to claim 32, wherein the method includes, responsive to a determination that the payment request is not in accordance with approved payment parameters, requesting, by the approval server, manual authorization of the payment request by the customer using the client device.

38.-44. (canceled)
